(19) United States
(12) Patent Application Publication
(10) Pub. No.: US 2004/0019976 A1
(43) Pub. Date: Feb. 5, 2004

(54) Method and device for continuously treating synthetic fibers in a heat exchange chamber

(76) Inventors: Steffen Muller-Probandt, Bad Kissingen (DE); Rolf Machatschke, Theilheim (DE)

Correspondence Address: Stephen E Bondura, Dority & Manning, P O Box 1449, Greenville, SC, 29602-1449, US

(21) Appl. No.: 10/332,916

(22) PCT Filed: Jul. 11, 2001
(86) PCT No.: PCT/DE01/02643

(30) Foreign Application Priority Data
Jul. 14, 2000 (DE) 100 34 540.9

(51) Int. Cl. B08B 3/12

(52) U.S. Cl. 8/151; 68/5 D; 8/151.2

(57) ABSTRACT

The invention relates to a method and device for continuously treating synthetic fibers in a heat exchange chamber, in which the fiber to be treated comes into direct contact with the heat exchange medium. A sealing device, which is subjected to the action of a sealing medium, which is provided at the fiber exit opening and at the fiber entry opening with a supply line for the sealing medium, which is arranged in the proximity of the fiber exit opening or the fiber entry opening. The sealing medium is kept away from the fiber passing through the heat exchange chamber. This is achieved by removing the sealing medium before the heat exchange chamber or also by removing the heat exchange medium together with the sealing medium. A removal line for the sealing medium is arranged in the proximity of the heat exchange chamber. In addition, the heat exchanger is provided in a separable manner so that the fiber can inserted by removing one part.

### DESCRIPTION

The invention concerns a method and a device for the continuous treatment of synthetic threads in a heat exchange chamber, in which the threads to be so treated come into direct contact with a heat exchange medium. The said heat exchange chamber possesses a thread exit opening and a thread inlet opening and which heat exchange is connected to sealing apparatuses with a sealant having the feed lines placed proximal to the respective thread outlet and inlet.

Such an apparatus has been disclosed by EP 0 624 208 B1. The heat exchanger can be applied as an apparatus both for heating and cooling. In either case, a fluid, hot or cold, comes into direct contact with the thread. The fluid, in this operation, is to be found in a heat exchange chamber through which the said fluid flows. This heat exchange chamber is, essentially, constructed in tubular shape and possesses a small boring on each of its ends, through one of which the thread is introduced, and after running through said chamber, exits from the other.

In this type of cooling or heating device, the problem arises of preventing the heating or cooling fluid from penetrating through the thread inlet or outlet. In accord with the state of the technology, i.e. DE-OS 24 30 741, for the solution to this problem, various sealing means are known, such as roller seals, lip type seals, and particularly, labyrinthine sealing, wherein the latter, because of its simple construction is predominately used. For example, such a labyrinthine seal has been made known by EP 760 874 (which corresponds to WO 95/32325). The labyrinthine seal comprises a plurality of choke passages, which are bound together by even smaller openings. The openings are just large enough, so that the thread can be conducted through.

For the support of the sealing effect, compressed air is employed. Instead of compressed air, steam or superheated steam has been proposed.

Present experience has indicated, that sealing of the said type is indeed effective, especially in the case of a gaseous medium. On the other hand, however, the sealing medium also intrudes into the heat exchange chamber and combines itself with the heat exchange medium, which is generally a liquid, for example, water, to form a foam. This problem with the foam particularly arises, when a gaseous sealant medium and a liquid heat exchange medium are employed.

In the case of a horizontal disposition of the heat exchanger, foaming plays a minor role, since the foam forms mostly above the surface of the liquid, to which surface the threads run parallel but through the liquid below. In this way, the heat exchange with the thread by direct contact with the heating medium remains largely undisturbed. In many cases, however, it is necessary, that the heat exchanger (or cooler) be situated not horizontally, but rather vertically or at an optional incline. In these non-horizontal cases, the heat exchanger has a zone in the upper end, which contains only foam. This leads to a situation, wherein the heat exchange effect is substantially impaired and extensively greater treatment stretches become necessary.

Thus, the purpose of the invention is, to set aside these deficiencies of the state of the technology and to create a sealing of the thread passage openings of the heat exchanger, which does not impair the effectivity of the heat exchanger.

This purpose is achieved in accord with the method as set forth in claim 1 and in accord with the heat exchanger, as is described in the claims 11, 15 and 17.

The invention rests upon the recognition, that the effectiveness of the heat exchange can be very much improved, if the sealing medium can be distanced from the thread, which passes completely through the heat exchange chamber. The reason for this is that the sealing medium, for example, air—like all other gaseous media—exerts a strong insulating action. In achieving this separation, the point is, surprisingly, not so much that mainly no sealing medium enters the heat exchange chamber and there mixes with the heat exchange medium, but rather that the sealing medium is to be kept away from the thread, so that only the heat exchange medium can act on the thread whereby stable and predictable relationships for heat exchange are created.

A fluid sealing system is described by the U.S. Pat. No. 3,783,649, which is stated to hinder the penetration of sealing medium into the heat exchange chamber and to prevent the mixing thereof with the heat exchange medium in said chamber. In the case of this system, the fluid itself takes on the function of a sealing apparatus and forms a fluid seal ahead of the material inlet or outlet of heat exchange chamber. To carry this out, a fluid, for example water, is directed at a high velocity against a passage opening of the heat exchange chamber. Then, by means of the exit velocity of the sealing medium issuing out of a sealing medium reservoir, determination can be made of both the outlet/inlet openings for the sealing fluid, as well as the passage openings for the textile material which are placed respectively before or after the entry or exit openings in the heat exchange chamber. The sealing fluid, to the extent it does not build up a kind of fluid congestion due to the static pressure, is conducted to a so-called overflow chamber with the textile material and is there retained or withdrawn. Ignoring the fact, that for a balance of this kind between the leakage pressure out of the heat exchange chamber and the sealing fluid, i.e. its velocity, a complicated pressure control becomes necessary, and the described fluid sealing system is expensive both as to occupied space as well as in the cost of manufacture.

The present invention differentiates itself from the state of the technology stated above, principally therein, in that it employs a customary sealing apparatus, for instance a labyrinth sealing, that is subjected to a sealing medium, and it is not the sealing medium itself which forms the sealing device. The invented heat exchanger, both in its construction as well as in its manipulation, is essentially simpler and in the pressure distributions, is completely without problems. Beyond this, the heat exchanger permits a monitored, controlled transfer of heat for thread treatment.

From DE-OS 2 002 349, a procedure and an apparatus for the sealing of neighboring spaces emerges, whereby a gaseous medium contained in the respective spaces is removed by suction and in the area of a slot, that is, a passage opening, situated at a small angle in reference to the material flow, the said gaseous medium is once again blown back into a corresponding space. This known procedure has shown itself to be non-adaptable in the prevention of foam building, since, with the introduction of a liquid heat exchange medium, an injector action arises, by means of which the unmonitored air is sucked away and mixed with the fluid to foam.

In this method, the sealing medium, with which the sealing apparatus is supplied, is removed ahead of the heat exchange chamber, which prevents this from entering the heat exchange chamber, and thus the sealing medium cannot come into contact with the thread running through the heat exchange chamber.

The removal of the heat exchange medium through the thread passage openings has the advantage, that a precise balancing of the sealing and the heat exchange media is not necessary. The heat exchange medium, must, in any case, be withdrawn from the heat exchange chamber to the outside. In principal, the mixing of the heat exchange medium and the sealing medium is displaced to a point outside of the heat exchange chamber, so that the sealing medium is kept distanced from the thread in the heat exchange chamber.

In the interests of simplicity, the heat exchange medium is withdrawn together with the sealing medium, whereby, subsequently, a separation of heat exchange medium and sealing medium can be carried out.

Another method of keeping the sealing medium away from the threads running through the heat exchange chamber is carried out in that the sealing medium does enter into the heat exchange chamber and at a certain elevated pressure, the heat exchange medium is prevented from leaving the heat exchange chamber. However, the sealing medium which enters the heat exchange chamber is diverted away from the threads, so that its insulating effect on the heat exchange medium is prevented.

Another method for the distancing of the sealing medium from the threads which are passing through the heat exchange chamber is carried out in such a manner that the heat exchange medium inside the heat exchange chamber is guided onto the threads, so that the direct effect is increased, and the sealing medium which has migrated into the heat exchange chamber is held away from the thread by the flow.

If the penetration of the sealing medium and the formation of foam is under control, then, a planned foam space becomes possible, and thereby a shortening of the heat exchange stretch can be made, whereby compliance with various operational conditions, for instance, a change of the thread throughput speed, can be carried out in a simple manner.

Corresponding to a generally applied way of procedure, the heat exchanger is provided with exit ports for the sealing medium, which ports are placed proximal to the thread passage openings in the heat exchange chamber. The sealing apparatus includes advantageously, a labyrinth sealing train, made up of multiple choking spaces. Because the feed line opening is situated between the thread exit or inlet and opens into the nearest positioned choking space, a safety arrangement for sealing medium loss is provided, while the exit line out of the heat exchange chamber at the next positioned choke space leads outward, so that both the sealing medium as well as the leakage from the heat exchange chamber can be led away at atmospheric pressure. For the diversion of the sealing medium, which has penetrated into heat exchange chamber, within the heat exchange chamber, diversion vanes have been placed, through which the thread can be conducted, but which, however, keep the said penetrating sealing medium away from the thread.

For the introduction of the heat exchange medium and the improvement of direct contact with the threads passing through the heat exchange chamber, in this chamber, and centrally located with respect to the thread, narrowed passages are provided, whereby the inlet and the outlet of the heat exchange medium are placed, respectively, before and after the group of said narrowed passages. This again allows the heat exchange medium to flow in a direction counter to the travel direction of the thread.

If the outflow of the sealing medium is made from the choke chamber placed before or after the heat exchange chamber in the heat exchanger, at a suitable distance from the thread passage opening, then, surprisingly, a contacting flow of the sealing medium in the area of the thread passage opening is prevented, wherein the sealing medium from the outflow line in the heat exchange chamber is held so distant from the thread, that any deterioration of the heat exchange is avoided. This formulation of the heat exchanger especially has the advantage, that a controlled foam formation and therewith a monitored, changeable length of the cooling stretch can be achieved in a simple manner.

An arrangement of the heat exchange chamber, which has shown itself to be especially advantageous for all applications having this said controllable cooling stretch, is that the run of the thread is allowed to intersect the surface of the cooling liquid. This is the case, for instance, where the heat exchange chamber is mounted vertically.

Further details of the invention are described with reference to the drawings. There is shown in:

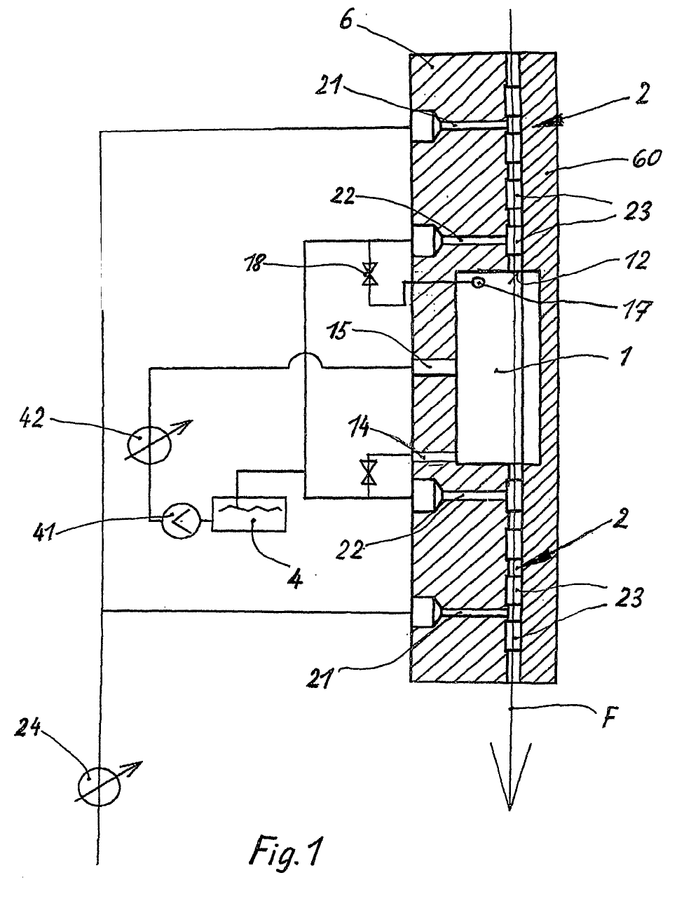

FIG. 1 the heat exchanger in sectional view, with a schematic presentation of the connection lines,

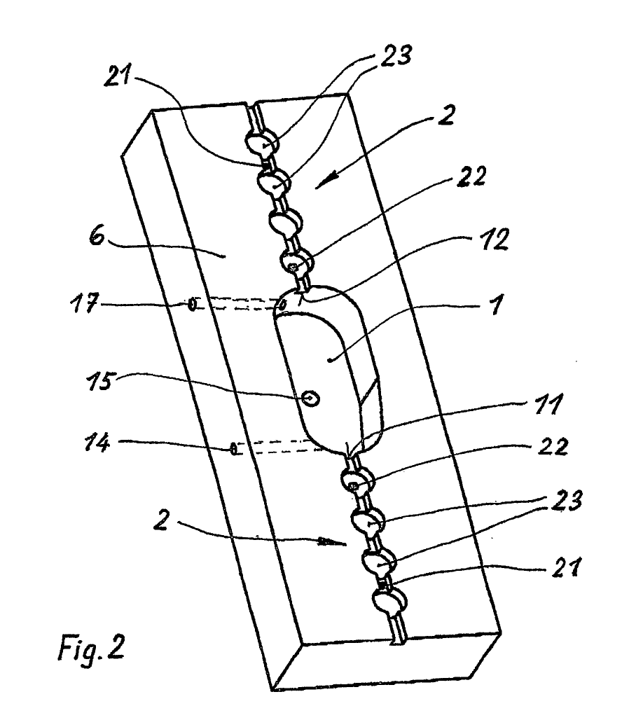

FIG. 2 the basic body of the heat exchanger in accord with FIG. 1 in a perspective view,

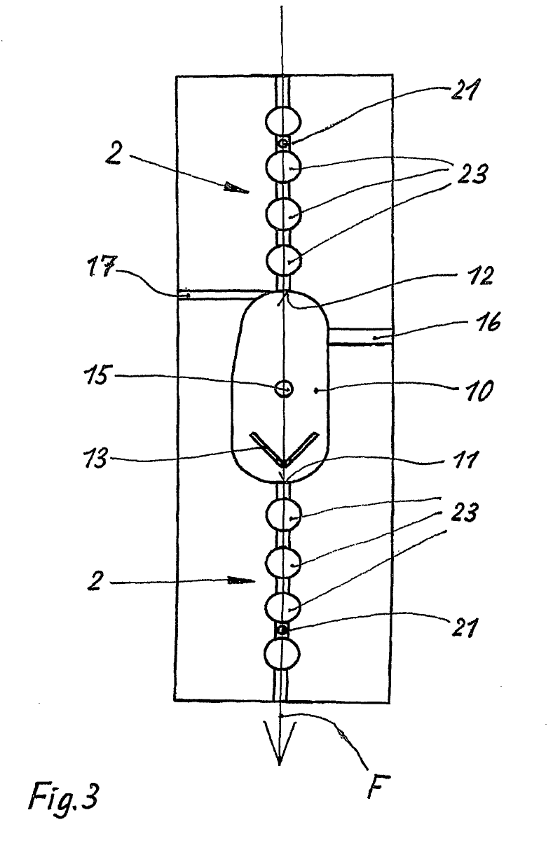

FIG. 3 another embodiment of the heat exchanger with diversion vanes,

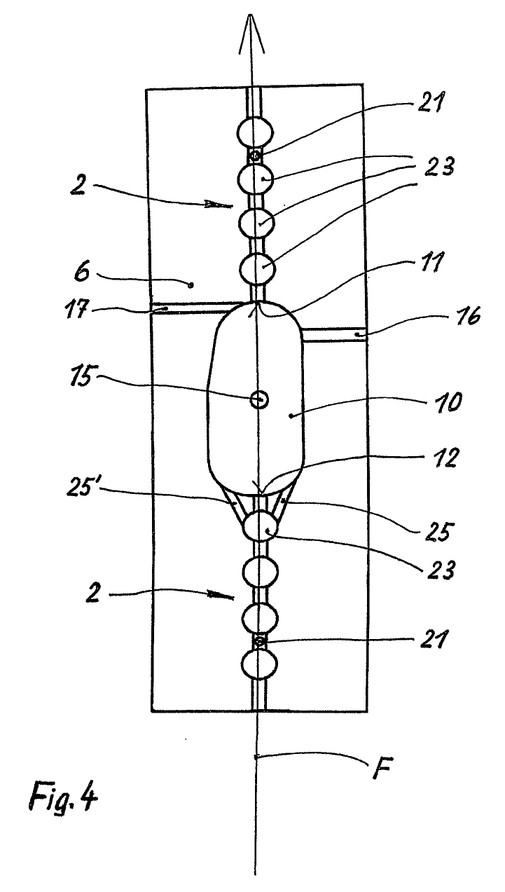

FIG. 4 a further embodiment of the heat exchanger with outflow line for the sealing medium, and

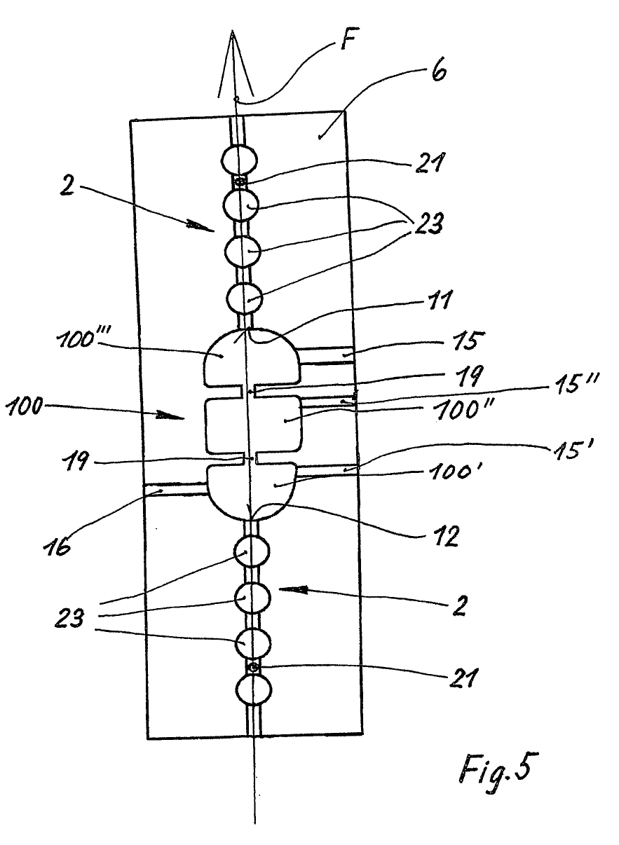

FIG. 5 yet another embodiment of the heat exchanger with narrowed portions of the heat exchange chamber.

The description of the invention will be made on the basis of a heat exchanger, which has been installed as a cooler in a texturizing process for a synthetic thread, wherein the thread to be treated runs through this cooler at a high speed, that is to say, at a speed of over 2,000 m/min velocity. This requires a very large cooling capacity in order to cool down the thread in a short time from some 200° C. to approximately 50° C. As a cooling medium, water is employed, which comes into direct contact with the thread. For the sealing medium in the sealing apparatus 2, air is used. Obviously, other heat exchange media or sealing media can be used, in accord with the process at hand and the purpose for which the heat exchanger has been installed.

The heat exchanger is further described on the basis of an application for the treatment of synthetic threads, however, it is obviously suited for the treatment of textiles or films.

FIG. 1 shows a heat exchanger designed as a cooler, having a base body 6 and its cover 60. The heat exchanger is so partitioned, so that upon the removal of the cover 60, the thread path in the base body 6 is exposed, allowing the thread F to be inserted without hindrance.

Advantageously, for a vertically aligned heat exchange chamber 1, a drain port 14 is provided, to make possible the removal of the cooling medium before the opening of the heat exchange chamber 1.

The heat exchanger has a heat exchange chamber 1 with a thread entry opening 12 and a thread exit opening 11. For the prevention of leakage of the cooling liquid, a sealing apparatus 2 is installed respectively before the inlet opening 12 and following the exit opening 11. For the sake of simplicity, this sealing apparatus 2 comprises a labyrinthine sealing means with choke spaces 23, through which the thread F is conducted from above to below. The sealing apparatus 2 is supplied with a sealing medium, in this case air, through an inflow line 21. This feed of the sealing medium is effected between the first two choke spaces 23, through which the thread F runs upon its entry into the heat exchanger. The sealing medium is withdrawn through an outflow line 22 from the last choke space 23 just before the thread entry 12 of the heat exchange chamber 1. The cooling medium can also flow to this last choke space 23 before the thread entry 12, and similarly, to the choke space 23 after the thread exit 11, up to the point where the said cooling medium is repressed by the sealing medium.

The heat exchange chamber 1 possesses a feed line 15 for the cooling medium, which flows through the said heat exchange chamber 1. Above the thread entry opening 12 and under the thread exit opening 11, the cooling medium is withdrawn from the heat exchange chamber 1 and picked up at both the choke space 23 before the thread entry opening 12 and after the thread exit opening 11.

Then, together with the sealing medium, the said cooling medium is led away by means of the outflow line 22 to collect in a reservoir 4, which also serves as the cooling medium reserve. In this way, no mixing occurs in the heat exchange chamber 1 of the heat exchange medium and the sealing medium, with the result that the heat exchange chamber 1 remains foam free.

A mixing of the air with the water is carried out only outside of the heat exchange chamber 1, since the cooling medium and the sealing medium only come in contact with one another in the thread exit opening 11 and the thread entry opening 12.

Should, nevertheless, foam build up in the heat exchange chamber 1, especially at the start of the procedure, then this foam will be removed by means of a deaerating boring 17 when the dearating valve 18 is open. In the case of a horizontal arrangement of the heat exchange chamber 1, this said dearating boring 17 is placed advantageously in the cover 60. When the heat exchange chamber 1 is vertical, the level of the surface of the cooling medium can be controlled by this deaeration boring in combination with the said valve 18, so that a desirable cooling travel stretch is attainable.

The circulation of the cooling medium is controlled by a pump 41 which in turn is governed by a pressure controller. Likewise the sealing medium is monitored by means of a pressure controller 24 and conducted to the feed lines 21 to the two sealing apparatuses 2.

Since the withdrawal of both the cooling medium and sealing medium is done in a choke space 23, this being a location where the pressure of the two media is reduced, an exact pressure control installation for a balance between the two media is not necessary. The pressure of the cooling medium is at just such a level, that the desired circulation can occur, while the sealing medium is subjected to just enough pressure, that the choke space 23 with the outflow opening 22 is reached. Both media, at this point, are relieved of pressure and flow at atmospheric pressure back into the reservoir 4. In the reservoir 4, the cooling medium separates from the air, so that a generation of foam occurs.

At the same time, in the reservoir a cooling down of the cooling medium can take place, before the cooling medium is once again recirculated into the heat exchange chamber through the feed line 15.

FIG. 2 shows the basic body in a perspective view, which displays both the heat exchange chamber as well as the sealing apparatus 2 along with all connection fittings for the entry lines 21 and the outflow lines 22, 14 and 17 as shown in FIG. 1.

FIG. 3 shows another mode of construction of the heat exchanger 1, in which, once again, the thread F travels from top to bottom. The sealing medium, for example, air, is fed in through line 21 to the sealing apparatus 2, which, in the depicted case, is designed as a labyrinth sealing means and possesses, respectively, four choke spaces 23, in order to seal off the thread outlet opening 12 of the heat exchange chamber 10, as well as the thread entry opening 12. With this design, no outlets for the sealing medium are provided, however, for the cooling medium, which enters the heat exchange chamber 10 through the feed entry 15, an outflow opening 16 is provided, so that the heat exchange chamber 10 is subjected to the full flow of the cooling medium. The sealing medium is added at such a pressure through the inflow opening 21 of the sealing apparatus 2, that an outward flow of the cooling medium through the thread passage openings (11, 12) of the heat exchange chamber 10 is prevented. Especially, at the thread exit opening 11, in a case of predominately vertical alignment, bubbles of the sealing medium in the liquid cooling medium rise to the top, in such a manner that the result would be an undesirable formation of foam within the heat exchange chamber 10. Beyond this, the rising air bubbles, which have an insulating effect, disturb the heat exchange between the thread F and the cooling medium. On this account, a V-shaped diversion vane 13 is placed directly before the thread exit opening 11 (as seen in the direction of the thread travel), so that the rising air bubbles are diverted to the side and in this way are held distant from the thread F. The V-shaped diversion vane 13 possesses, however, a narrow passage for the thread F at its apex, so that the air bubbles cannot rise at that point.

Because the travel direction of the thread F is counter to the motion of the air bubbles, these also cannot be entrained by the moving thread F.

In the case of a reversed running direction of the thread F, the air bubbles would be stripped away from the thread F by the diversion vane plates and again directed to the side. The rising air bubbles and probably the foam buildup is removed together with the cooling medium by means of the outflow line 16.

In a like manner, as in the case of FIG. 1, a treatment of the mixture of cooling medium and sealing medium is carried out for the separation of the air and the water, the cooling of the air free water, and its recirculation into the system. By means of a deaerating opening 17, the sealing medium can be removed, a controlled level of the cooling medium obtained and therewith a variable cooling stretch produced.

FIG. 4 shows another embodiment of the object of the invention. Also, in this case both sealing apparatuses 2 are supplied with sealing medium by the inflow line 21, wherein the sealing medium consists, advantageously, of air. The cooling medium is fed in through its inlet line 15 and again removed from the heat exchange chamber 10 by means of the outflow line 16. In order to prevent, that at the bottom thread entry opening 12, the sealing medium can be entrained with the thread into the heat exchange chamber 10, whereby the rising bubbles would exert their insulating effect on the thread F, the sealing means is conducted into the heat exchange chamber 10 through outflow lines 25 and 25′ branching from the choke space 23 immediately before the thread entry opening 12. However, the said branching lines 25, 25′ are separated by a given space from the thread inlet opening 12, so that the bubbles are held at a distance from the thread F and rise laterally against the walls of the heat exchange chamber 10. An advantage of this design is that an essentially improved cooling capacity is achieved.

FIG. 5 shows a further embodiment form of the heat exchanger in accord with the invention. The thread travel in this case is from bottom to top, although it could also be constructed to be in the reverse direction with no difficulty. The sealing apparatuses 2 are, likewise, as described above, provided with inflow lines 21 for the sealing medium and provided with air as the sealing medium. It is possible that outflow lines for the sealing medium 22 in accord with FIG. 1, or alternately, bypass lines such as 25, 25′ in accord with FIG. 4 could be furnished.

Even a diversion vane 13, as depicted in the design shown in FIG. 3 can be considered and employed. The special feature of this design is to be found therein, in that the heat exchange chamber 100 is subdivided by restrictive passages 19 into chambers 100′, 100′″ and 100″″, whereby the feed of the cooling medium is made through the feed line 15 and the removal of the same through outflow line 16, so that the combined heat exchange chamber 100 has a cooling flow counter to the direction of travel of the thread F.

The possibility exists, that the thread, because of the distribution of twist of the texturizing process, forms a bulb and transmits the turning to the cooling means. The cooling means, by centrifugal force, is forced into the wall areas of the heat exchange chamber 100, while the rising bubbles remain in the center in proximity to the thread F, whereupon this thread F comes into contact with said rising air bubbles of the sealing medium. In order to defeat this, narrowed passages 19 are provided, so that the thread F is held centered in the middle of the heat exchange chamber 100. The narrowed passages act further, in that the flowing of the cooling medium at these points is reinforced, so that here the rising air is again held distant from the thread F by means of the acceleration of the cooling medium. This design has also demonstrated, that the cooling action can be substantially improved.

By means of the distancing of the sealing medium from the thread running through the heat exchange chamber, a substantial improvement in cooling is obtained. This is up to 40% more effective. Beyond this, the cooler requires less water and less air. It is possible that because of the improved cooling capacity, essentially shorter cooling lengths can be realized, particularly in the non-horizontal installations. This obvious increase of the efficiency of the heat exchanger is based on an air free, at least bubble poor, water flow within the heat exchange chamber. The thread no longer comes into contact with the bubbles of the sealing medium, so that, during the throughput of the thread in the heat exchange chamber, the thread remains in constant contact with the heat exchange medium. The leakage of the cooling medium is simultaneously made use of for the closing of the said heat exchange chamber against inward migrating sealing medium. Common to all described embodiments is that they hold the sealing medium away from the thread F during its transit through the heat exchange chamber. This is done, either by the fact that the sealing medium does not enter into the chamber at all, or because the sealing medium within the chamber, is diverted away from the thread. The described embodiments can, as already mentioned above, be used as themselves, although using one or more combinations among them gives advantageous possibilities.

The possibility, which lies also in the framework of the invention, exists, that by means of appropriate pressure regulation of the sealing medium and/or the heat exchange medium, a foam buildup space can be made, so that the actual and especially effective cooling stretch can be made shorter. Thus, for example, in a simple way the cooling can be made effective at reduced through-flow velocities. For this purpose the chamber subdivisions as seen in FIG. 5 can be used, although only two chambers alone are effective by the cooling medium, while the third chamber contains foam or air, which is not at all effective for the cooling. In this case, it is advantageous to install cooling medium feed lines 15″ and 15′ also in the chambers 100″ and 100′, in order that optionally, one, two or all three chambers might be selected for cooling medium throughflow.

In the case of the described embodiment, the basic concept is held, that the sealing medium, through the feed lines 21, subjects the sealing apparatus 2 to elevated pressure. Experience, however, has shown good results may be achieved by bringing a suction arrangement onto the outflow lines 22, so that the sealing apparatus 2 is under suction. Heat exchange medium, migrating out of the thread passage openings 11 and 12, would be, by this suction, immediately removed and guided back into the cooling medium circulation system. The feed lines 21 could then be omitted, whereby the suction action in the choke space 23, would be increased in regard to the leakage.

Namely, at the thread exit opening 11, where the thread F leaves the heat exchange chamber and is saturated with cooling medium, by means of the inflow of sealing medium, this being air, on the sealing apparatus, a quick drying of cooling medium from the said thread F will occur, no matter whether at elevated or suction pressure.

Reference numbers and Corresponding Parts

F Thread

1, 10, 100 Heat exchange chamber

100′, 100″, 100′″ Partial heat exchange chambers

11 Thread exit opening

12 Thread entry opening

13 Diversion vane

14 Outlet opening (of heat exchange chamber)

15, 15′, 15″ Feed line for heat exchange medium

16 Outflow line for heat exchange medium

17 Deaeration boring

18 Deaeration valve

19 Narrowing (between partial heat exchange chambers)

2 Sealing apparatus

21 Inflow line (for cooling/heating medium)

22 Outflow line (for sealing medium)

23 Choke space

24 Pressure controller (for sealing medium)

25, 25′ Outflow lines (by-passes for sealing medium—see FIG. 4)

4 Reservoir (Temp. adjustment, air separation, recirculation)

41 Pump, for heat exchange medium

42 Pressure regulator for heat exchange medium

6 Basic body

60 C v r to basic body

### Claimed is:

1. A method for the sealing of a heat exchanger for the continuous treatment of synthetic threads in a heat exchange chamber, in which the thread to be treated comes into direct contact with the heat exchange medium, and which heat exchange chamber possesses a thread exit opening and a thread entry opening, on which said chamber, is provided a sealing apparatus, which is supplied with a sealing medium, and said sealing apparatus has a feed line for the said sealing medium placed proximal to the said openings for thread exit and entry, therein characterized, in that the sealing medium is distanced from the thread running through the heat exchange chamber.

2. A method in accord with claim 1, therein characterized, in that the sealing medium is withdrawn ahead of the heat exchange chamber (1).

3. A method in accord with one of the claims 1 or 2, therein characterized, in that the heat exchange medium is introduced by means of a feed line (21) to the heat exchange chamber (1) and is removed therefrom by means of the thread exit opening (11) and/or the thread inlet opening (12) and the sealing medium is blocked from entry into the heat exchange chamber (1) by the heat exchange medium flowing out through the thread passage openings (11;12) at the entry into the heat exchange chamber (1).

4. A method in accord with one or more of the foregoing Claims, therein characterized, in that the removal of the heat exchange medium is carried out together with the removal of the sealing medium.

5. A method in accord with one or more of the foregoing Claims, therein characterized, in that the heat exchange medium, together with the sealing medium is removed, treated, and the heat exchange medium is recycled in the heat exchanger (1).

6. A method in accord with claim 1, therein characterized, in that the sealing medium penetrating into the heat exchange chamber (1) is directed away from the thread (F).

7. A method in accord with one or more of the foregoing Claims, therein characterized, in that the heat exchange medium flowing through the heat exchange chamber (1) is directed within the said heat exchange chamber (100) against the thread (F), in order to increase the direct contact of the thread with the heat exchange medium.

8. A method in accord with one or more of the foregoing Claims, therein characterized, in that the course of travel of the thread intersects the surface level of the cooling medium.

9. A method in accord with claim 8, therein characterized, in that the pressure difference between the sealing medium and the heat exchange medium is so adjusted, that the sealing medium penetrates, under control, into the heat exchange chamber (1, 10, 100), so that a defined surface level can be determined between the heat exchange medium and the mixture of heat exchange medium and the sealing medium (in the form of foam), whereby the desired effective heat exchange stretch in the heat exchange chamber (1, 10, 100) can be adjusted.

10. A method in accord with one or more of the foregoing Claims, therein characterized, in that, in the case of a predominately vertical placement of the heat exchanger, the thread travels from above to below.

11. A heat exchanger for the continuous treatment of synthetic threads in a heat exchange chamber (1, 10), in which the thread (F) to be treated comes into direct contact with the heat exchange medium, and which said heat exchange chamber possesses a thread exit opening (11) and a thread entry opening (12), and has a sealing apparatus (2) supplied with a sealing medium, and said sealing apparatus (2) has a feed line (21) for the said sealing medium placed proximal to the thread exit opening and to the thread entry opening, therein characterized, in that, proximal to the heat exchange chamber (1, 10), is placed an exit line (22; 25, 25′) for the sealing medium.

12. A heat exchanger in accord with claim 11, therein characterized, in that the sealing apparatus (2) is a labyrinth seal, which exhibits choke spaces (23).

13. A heat exchanger in accord with one of the claims 11 or 12, therein characterized, in that the feed line (21) opens between the choke spaces (23) which are most proximal to the respective thread exit opening (11) and thread inlet opening (12), while the outflow line (22; 25, 25′) leads out of the heat exchange chamber (1, 10) to the nearest situated choke space (23).

14. A heat exchanger in accord with one or more of the claims 11 to 13, therein characterized, in that proximal to the thread passage openings (11; 12) within the heat exchange chamber (10), diversion vanes (13) are situated with a narrow opening for the thread (F), so that sealing medium penetrating through the thread openings (11; 12) is held distant from the thread (F).

15. A heat exchanger for the continuous treatment of synthetic threads in a heat exchange chamber (1, 10), in which the thread to be treated (F) comes into direct contact with a heat exchange medium and said heat exchange chamber possesses a thread exit opening (11) and a thread entry opening (12), on which, respectively, a sealing apparatus (2) supplied with a sealing medium is provided, having an inflow line (21) for the sealing medium placed respectively near the thread exit opening and the thread inlet opening, therein characterized, in that proximal to the respective thread passage openings (11; 12) within the heat exchange chamber, diversion vanes (13) are placed, said diversion vanes (13) having a small opening for the thread (F), so that sealing medium penetrating through the thread openings (11; 12) is held distant from the thread (F).

16. A heat exchanger in accord with one or more of the foregoing claims 11 to 15, therein characterized, in that the heat exchange chamber (100) possesses a narrow passage (19) centrally located with respect to the thread (F) and the feed lines (15) for the heat exchange medium and the outflow line (16) for the heat exchange medium are so placed before or after the narrowed passage, that flow of heat exchange medium in the narrowed passage (19) is advantageously in counter flow to the direction of travel of the thread (F).

17. A heat exchanger for the continuous treatment of synthetic threads in a heat exchange chamber (1, 10), in which the thread to be treated (F) comes into direct contact with the heat exchange medium and which heat exchanger possesses a thread exit opening (11) and a thread entry opening (12), on each, respectively, a sealing apparatus is provided supplied with a sealing medium, said sealing medium having an inflow line (21) placed near the openings for thread exit and thread inlet, therein characterized, in that the heat exchange chamber (100) exhibits a narrow passage (19) centrally aligned with the thread (F) and the inlet line (15) and the outlet line (16) of the heat exchange medium is so placed before or after the narrow passage (19), that the said narrow passage (19) allows a flow of the heat exchange medium to be counter to the direction of travel of the thread (F).

18. A heat exchanger in accord with one or more of the foregoing claims 11 to 17, therein characterized, in that the outflow lines (25, 25′) open into the heat exchange chamber (10) at a distance from the thread passage opening (11, 12) of the heat exchange chamber (10). (FIG. 4)

19. A heat exchanger in accord with one or more of the foregoing claims 11 to 18, therein characterized, in that the outflow line (22) opens into a separating reservoir (4) for the separation of the heat exchange medium from the sealing medium.

20. A heat exchanger in accord with one or more of the foregoing claims 11 to 19, therein characterized, in that the heat exchange chamber (1; 10; 100) has an emptying opening (14).

21. A heat exchanger in accord with one or more of the foregoing claims 11 to 20, therein characterized, in that the sealing medium is gaseous and the heat exchange medium is a liquid.

22. A heat exchanger in accord with claim 21, therein characterized, in that the sealing medium is air and the heat exchange medium is water.

23. A heat exchanger in accord with one of more of the foregoing claims 11 to 22, therein characterized, in that the heat exchanger is so partitioned, that by means of the removal of the one part (60) the thread (F) can be inserted.

24. A heat exchanger in accord with claim 23, therein characterized, in that the one part (60) is designed as a hinged or removable cover, while in the other part, designed as a basic body (6), all inlet and outlet lines open.

25. A heat exchanger in accord with one of more of the foregoing claims 11 to 24, therein characterized, in that the heat exchange chamber (1; 10; 100) are vertically aligned.

26. A heat exchanger in accord with claim 25, therein characterized, that the thread entry opening (12) is placed on the lower end and the thread exit opening (11) is placed on the upper end of the heat exchange chamber (10; 100).
